(19) United States
(12) Patent Application Publication
(10) Pub. No.: US 2026/0070260 A1
(43) Pub. Date: Mar. 12, 2026

(54) DECORATION METHOD AND MACHINE FOR THE SURFACE DECORATION OF A CERAMIC ARTICLE

(71) Applicant: SACMI TECH S.P.A., IMOLA(BO) (IT)

(72) Inventors: Mauro Bedini, Imola, Bologna (IT); Marco Cancellara, Imola, Bologna (IT); Gian Mario Guidotti, Imola, Bologna (IT)

(21) Appl. No.: 19/108,645

(22) PCT Filed: Sep. 8, 2023
(86) PCT No.: PCT/IB2023/058898

§ 371 Date: Mar. 4, 2025

(30) Foreign Application Priority Data
Sep. 8, 2022 (IT) 102022000018333

(51) Int. Cl. B28B 11/00; B41J 3/28; B41J 3/407; B41J 3/54; B41J 11/00; B41J 13/08; B41J 29/377; B41M 5/00; B41M 7/00; B65G 43/00

(52) U.S. Cl. CPC B28B 11/001; B41J 3/28; B41J 3/4073; B41J 3/543; B41J 11/0024; B41J 11/008; B41J 13/08; B41J 29/377; B41M 5/007; B41M 5/0088; B41M 7/009; B65G 43/00; B65G 2203/042

(57) ABSTRACT

Decoration method and machine for the surface decoration of a ceramic article; the decoration machine comprises: a conveyor device having a metal support structure and a belt to support and transport the ceramic article through a printing station at least circa 2 metres long; a printing assembly comprising a plurality of digital printing devices; a detection unit to detect a quantity correlated with the moving speed of the conveyor device; comprising a reference integral with the belt, a detector to detect each passage of the reference and a processing device calculating the time interval between successive signals from the detector; and a control unit to adjust the mutual operation of the different digital printing devices as a function of the quantity correlated with the moving speed of the conveyor device so as to apply a defined pattern on the surface of the ceramic article to be decorated.

### CROSS-REFERENCE TO RELATED APPLICATIONS

This Patent Application claims priority from Italian Patent Application No. 102022000018333 filed on Sep. 8, 2022, the entire disclosure of which is incorporated herein by reference.

### FIELD OF THE ART

The present invention relates to a decoration method and machine for the surface decoration of a ceramic article. The present invention also relates to a method and a plant to manufacture ceramic products; in particular, ceramic slabs and tiles.

### BACKGROUND OF THE INVENTION

In the field of the production of ceramic products, the need is increasingly felt to manufacture ceramic articles, such as ceramic slabs and tiles, having surface decorations on the visible surface adapted to reproduce the appearance of natural materials, such as wood or natural stones, for example marble, granites, etc.

Typically, to create such surface decorations, decoration machines are used which are adapted to apply on the surface to be decorated of ceramic articles, typically already dried, thus hot but still raw, a defined pattern, through the use of specific inks able to penetrate in the surface of each dried ceramic article by printing the desired decoration and, at the same time, to withstand the even higher temperatures to which the article itself will be subjected during the subsequent firing, without deteriorating or compromising the resolution of the decoration itself.

This type of decoration machines generally comprises a belt conveyor device, which in turn comprises a metal support structure around which a belt defining the transport plane is fitted and which moves the ceramic articles along a given path in a moving direction through a printing station, at which the mentioned pattern (i.e. the mentioned graphic) is applied by means of a printing assembly provided with a plurality of inkjet printing devices, also called printheads. Typically, in the ceramic field, in order to obtain a good resolution and maintain it even after the firing step at high temperatures, a printing assembly is used which is provided with a plurality of inkjet printing devices (in the most common cases, at least six inkjet printing devices; in the most modern systems, up to twelve inkjet printing devices), arranged one after the other along the moving direction of the conveyor device, which are operated by a control unit to apply, each one, at least part of said defined pattern as the ceramic article moves along the given path through the printing station, which therefore reaches an extension along the moving direction of the ceramic article of at least circa 2 metres.

A decoration method and device of known type adapted to form a pattern on at least part of an object provided at least partially with three-dimensional structure is, for example, described in patent document EP2213462B1.

The decoration methods and machines of known type, while generally guaranteeing excellent performance, have some drawbacks, among which we mention the following.

One of the main drawbacks is linked to the thermal variations to which the decoration machine may be subjected during its useful life, following thermal variations of the environment in which it is placed and/or the variation in temperature of the ceramic articles that said machine is intended to treat, which may induce consequent deformations of the components of the decoration machine itself. This problem is particularly evident when the decoration machines are intended to receive and decorate dried ceramic articles that, having just come out of the dryer, are hot, in particular have an average temperature (throughout their extension) of at least circa 35° C., and therefore they tend to transfer part of their heat to the belt conveyor device (in particular, both to the belt and to the metal support structure), which will be subjected to significant temperature variations during its useful life. It is evident that these temperature variations, which can be of the order of 20-30° C. in a couple of minutes, entail consequent deformations of the belt conveyor device and above all of the metal support structure, whose components will tend to expand or shrink as the temperatures increase or decrease.

These dimensional variations of the components of the metal structure of the belt conveyor device, in particular of the driving and return rollers around which the belt conveyor belt is fitted, entail consequent variations in the stretching of the belt and therefore in the moving speed of the dried ceramic articles. It is understood that these variations are all the more significant the higher the temperatures with which the dried ceramic articles show up in the area of the decoration machines and the longer the printing station is and/or the higher the thermal variations of the working environment in which the decoration machine operates are.

To this, one must add the deformations or in any case the dimensional variations to which the belt conveyor device is subjected (in particular, the metal support structure) upon variation of the time and the number of working cycles, as well as of the weight and of the dimensions of the various ceramic articles to be transported, which could, also in this case, induce deformations of the components of the metal structure.

All these variations (both those induced by the temperature variations and those more connected to mechanical drift phenomena) mean that the dried ceramic articles, by moving on the transport plane along the aforementioned given path, arrive at the various printing devices (printheads) of the printing assembly before or after the expected instant, assuming a use of the decoration machine and therefore of the conveyor device under optimal conditions (therefore at room temperature and with the metal structure undeformed). In other words, such dimensional variations lead to errors occurring in the positioning of the dried ceramic articles with respect to the different printing devices, with consequent errors and/or phase shifts in the application of the decoration by the different printing devices of the printing assembly.

This leads to defects in the defined pattern that is applied by the decoration machine, see in particular the row of patterns at the top in FIG. 5, with consequent loss of graphic quality of the finished ceramic product, which in the most serious cases can result in the rejection of the products themselves.

### DISCLOSURE OF THE INVENTION

Aim of the present invention is to provide a decoration method and a machine for the surface decoration of a ceramic article, which allow to overcome, at least in part, the limits of the prior art.

In accordance with the present invention there are provided a decoration method and machine for the surface decoration of a ceramic article, as claimed in the independent claims which follow and, preferably, in any of the claims directly or indirectly dependent on the independent claims.

The claims describe preferred embodiments of the present invention.

### BRIEF DESCRIPTION OF THE DRAWINGS

The invention will now be described with reference to the accompanying drawings, which show some non-limiting examples of embodiments thereof, in which:

FIG. 1 shows a schematic side view of part of a plant to manufacture ceramic products;

FIG. 2 shows a schematic side view of a decoration machine for the surface decoration of a ceramic article, according to a first embodiment of the present invention;

FIG. 3 shows a schematic side view of a decoration machine for the surface decoration of a ceramic article, according to a second embodiment of the present invention;

FIG. 4 shows a schematic side view of a decoration machine for the surface decoration of a ceramic article, according to a third embodiment of the present invention; and

FIG. 5 shows the comparison between the patterns printed by a traditional decoration machine, four patterns at the top, and those manufactured with a decoration machine according to the present invention, four patterns at the bottom.

### PREFERRED EMBODIMENTS OF THE INVENTION

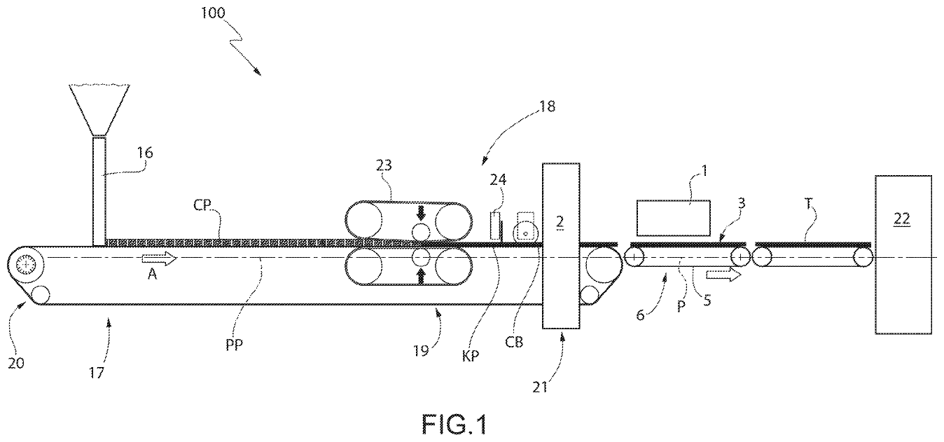

In accordance with a first aspect of the present invention, in the accompanying FIG. 1 denotes as a whole a decoration machine for the surface decoration of a ceramic article T; in particular, of an article comprising (raw) ceramic material. Advantageously but not in a limiting manner, in this discussion the expression “ceramic article T” is intended to refer to an article comprising (raw) ceramic material, possibly but not necessarily subjected to drying heat treatment; even more particularly (advantageously but not in a limiting manner), the expression “ceramic article T” is intended to refer to a raw article, or to a raw ceramic article already dried, thus subjected to drying but not yet fired.

Advantageously but not in a limiting manner, the ceramic article T comprises (in particular, is formed starting from) powder ceramic material CP comprising clay, sand, feldspars and other minerals, which is compacted so as to obtain a ceramic article, possibly subsequently dried, but not yet fired. According to some advantageous but non-limiting embodiments, the ceramic article T is a dried ceramic article and comprises (in particular, is) a ceramic article having

a temperature (average throughout its development) of at least circa 35° C.; more in particular of at least circa 40° C. Even more in detail, advantageously but not in a limiting manner, the ceramic article T is a ceramic article subjected to a drying heat treatment, then heated at a temperature of at least circa 80° C., in particular of at least circa 100° C., inside a dryer 2, no more than circa 3 minutes before (in particular, no more than 4 minutes) entering inside the decoration machine 1, as will be better explained below.

The ceramic article T also has at least one surface 3 to be decorated (in use, oriented upwards) and at least one further surface 4, which is parallel and opposite to the surface 3 to be decorated (in use, facing downwards).

Typically but not necessarily, the ceramic article T has a shape (in plan) substantially of a quadrilateral. More precisely, the ceramic article T has a shape substantially of a parallelepiped. In some specific and non-limiting cases, the ceramic article T has a substantially rectangular shape (in plan).

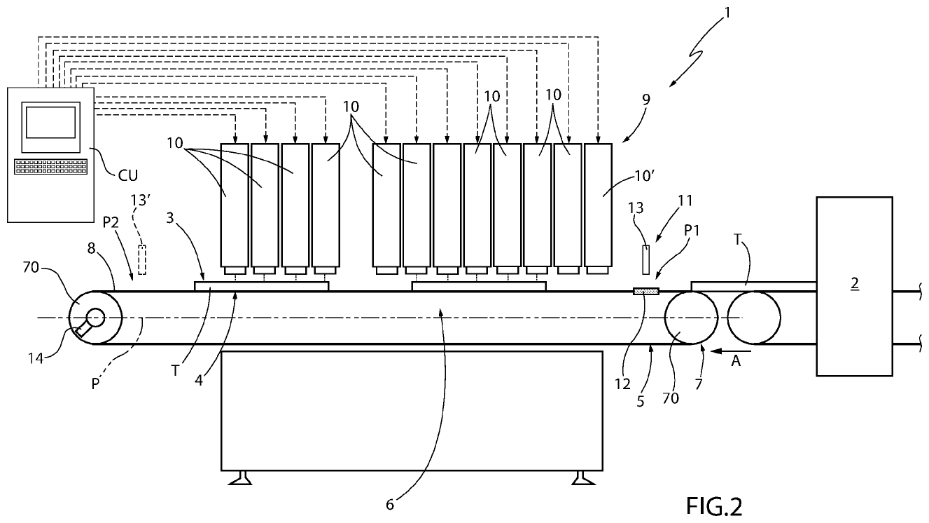

With particular reference to FIGS. 2 to 4, advantageously, the decoration machine 1 comprises: a conveyor device 5 which is configured to convey the ceramic article T along a given path P, in a moving direction A, through a printing station 6 and comprises, in turn, a metal support structure 7, and a belt 8 which is fitted on the metal support structure 7 and defines with a branch thereof a transport plane to support and transport the ceramic article T during its movement; and a printing assembly 9, which is arranged at the printing station 6, and is configured to apply a defined pattern (i.e. a defined graphic) on a surface 3 to be decorated of the ceramic article T and comprises a plurality of digital printing devices 10 arranged one after the other along the moving direction A; and a control unit CU configured to operate each one of said printing digital printing devices 10 of the printing assembly 9. According to some non-limiting embodiments (such as those shown in FIGS. 2 to 4), the printing assembly 9 comprises (in particular, is) a digital inkjet printer and the digital printing devices 10 are inkjet printheads. Advantageously but not necessarily, the printing assembly 9 comprises at least six (in particular, at least eight; even more in particular, between eight and twenty; more in particular, between four and twelve) digital inkjet printing devices 10 arranged one after the other along the moving direction A. In particular, advantageously but not in a limiting manner, the printing assembly 9 comprises at least one first printing device 10′, arranged at a starting position of the printing station 6, and at least three other printing devices (in particular, at least seven other digital printing devices 10; even more in particular, at least eleven other digital printing devices 10) arranged downstream of the first digital printing device 10′ along the moving direction A, one after the other, at the aforementioned printing station 6. Even more advantageously but not in a limiting manner, the digital printing devices 10 of the printing assembly 9 are arranged at a given distance from one another. In particular, the mutual distance between following digital printing devices 10 of the plurality of digital printing devices 10 is at least circa 10 centimetres between them; in particular, it ranges from circa 10 centimetres to circa 2 m.

In detail, in the advantageous but non-limiting embodiment shown in FIGS. 2 to 4, the printing assembly 9 comprises twelve digital printing devices 10, subdivided into two printing modules, the first having eight printing devices 10 and the second having four other digital printing devices 10 arranged distanced from each other and one after the other along the moving direction A. The large number of digital printing devices 10 allows, advantageously, to create more precise patterns or graphics, having a good resolution and able to maintain this resolution even after firing the dried ceramic articles T.

Advantageously but not in a limiting manner, the printing station 6 extends along the moving direction A for a length of at least circa 2 metres; in particular, of at least circa 4 metres; even more in particular equal to at least circa 6 metres.

Advantageously, the decoration machine 1 also comprises a detection unit 11 configured to detect, advantageously but not necessarily continuously, a quantity correlated with the moving speed of the conveyor device 5 (in particular, of the transport plane defined by the belt 8) and the aforementioned control unit CU is configured to adjust, advantageously but not in a limiting manner retroactively, the mutual operation of the different digital printing devices 10 of the printing assembly 9 as a function of the quantity correlated with the moving speed of the conveyor device 5 (detected by the detection unit 11) so as to apply the aforementioned defined pattern on the surface 3 to be decorated of the ceramic article T; in particular, so as to apply precisely the aforementioned defined pattern on the surface 3 to be decorated also when the actual moving speed of the conveyor device 5 varies, i.e. regardless of the different factors, such as for example temperature and actual pull of the belt 8, which might influence the speed of the conveyor device 5. This allows to take into account in real time any variations in the moving speed of the conveyor device 5, as the temperature of the metal structure 7 and/or the pull of the belt 8 vary (for example because of deformations induced by environmental factors, such as temperature, and/or of mechanical factors), without compromising the quality of the defined pattern to be applied on the surface 3 to be decorated of the ceramic article T.

Advantageously but not in a limiting manner, the conveyor device 5 (per se known) in particular the metal structure 7 comprises a pair of driving rollers 70 (schematically represented in FIGS. 2 to 4) arranged parallel to each other at a given distance from one another ranging from circa 2.5 metres to circa 12 metres (in particular, from circa 3 metres to circa 10 metres; even more in particular, equal to circa 4 metres) along the moving direction A and the belt 8 is fitted on said pair of driving rollers 70 so as to be stretched and operated, in its movement, by the rotation of said driving rollers 70. According to some advantageous but non-limiting embodiments, the belt 8 (per se known) comprises (in particular, is made of) a double aramid fibre weft coated in polyurethane.

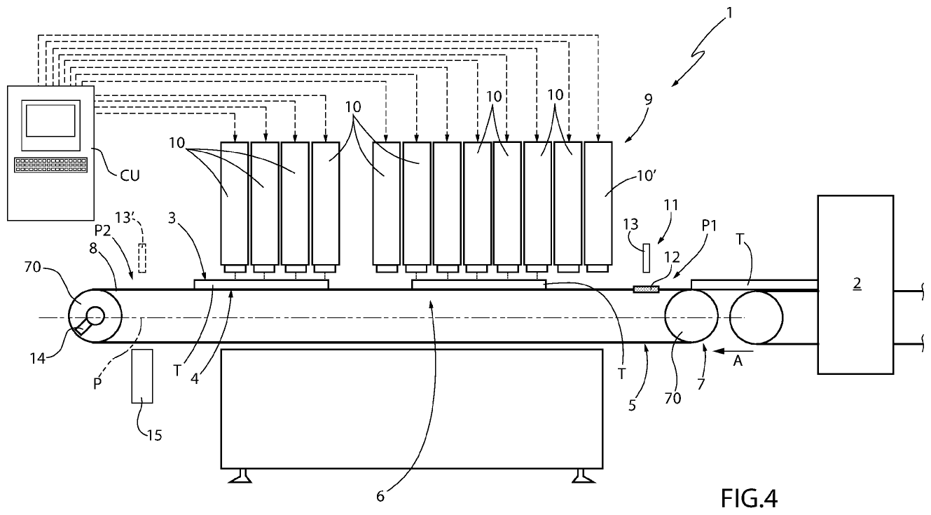

According to some advantageous but non-limiting embodiments (such as the one shown in FIGS. 2 and 4), the detection unit 11 comprises: a reference 12 which is integral with the belt 7; at least one detector 13 configured to detect each passage of the reference 12 at a first given position P1 and to emit a corresponding detection signal; and a processing device (not visible in the attached figures) connected to the detector 13 to receive each detection signal and estimate the aforementioned quantity correlated with the moving speed of the conveyor device 5 (in particular, of the belt 8 of said conveyor device 5; more in particular, of the aforementioned transfer plane) as a function of the variation (over time) of a quantity correlated with the distance covered by the reference 12 (in particular, in the time elapsing) between the emission of two following detection signals by the detector 13 (more in particular, between two following passages of the reference 12 at the aforementioned first given position P1).

In detail, advantageously but not in a limiting manner, the processing device is configured to estimate a quantity correlated with (in particular, coinciding with) the distance covered by the reference 12 between two following passages of the reference at the aforementioned first given position P1 and to cyclically compare the last estimated value of this quantity with the previous one so to evaluate the aforementioned quantity correlated with the moving speed of the conveyor device 5 (in particular, of the belt 8 of said conveyor device 5; more in particular, of the aforementioned transfer plan) as a function of the variation over time of the estimated values of the quantity correlated with the aforementioned distance covered by the reference 12 between the emission of two following detection signals by the detector 13 (in particular, between two following passages of the reference 12 at the aforementioned first given position P1).

Alternatively or in combination, according to some advantageous but non-limiting embodiments, the processing device is configured to estimate the aforementioned quantity correlated with the moving speed of the conveyor device 5 (in particular, of the belt 8 of said conveyor device 5; more in particular, of the aforementioned transfer plane) as a function of the time interval elapsing between the emission of two following detection signals by the detector 13. According to some advantageous but non-limiting embodiments (such as the one schematically shown in FIGS. 2 to 4), the processing device is comprised, in particular coincides, with the control unit CU of the decoration machine 1.

According to some advantageous but non-limiting embodiments such as those shown in FIGS. 2 and 4, the reference 12 is a metal plate fixed (for example vulcanized) to the belt 8. It is understood that according to other embodiments not shown, the reference 12 could be of any other type, for example a hole or a notch made in the belt, another type of indicator (other than the metal plate) inserted in the structure of the belt itself, etc.

Advantageously but not in a limiting manner, said reference 12 is arranged at a lateral end zone of the belt 7 itself; in particular, at a zone which, in use (i.e. while the ceramic article T on the transport plane defined by the belt 8), is not affected (covered) by the passage of the ceramic article T on the belt 8 itself. It is understood that according to other non-shown and non-limiting embodiments, said reference 12 could be arranged in any other position, as long as it is detectable by the detector 13.

According to some advantageous s but non-limiting embodiments (such as those shown in FIGS. 2 and 4), the detection unit 11 moreover comprises a further detector 13′, advantageously of the same type as the detector 13, configured to detect each passage of the reference 12 at a second given position P2, which is arranged downstream of said first given position P1 along the given path P, and to emit a corresponding detection signal at each passage of the reference 12 at said second given position P2. In this case, advantageously but not in a limiting manner, the aforementioned processing device is configured to estimate the quantity correlated with the moving speed of the conveyor device 5 (in particular, of the belt 8 of the conveyor device 5) also as a function of the variation over time of a quantity correlated with (in particular, coinciding with) the distance covered by the reference 12 between the emission of a detection signal by the detector 13 and the emission of a detection signal by the detector 13′ (in particular, between a passage of the reference 12 at the aforementioned first given position P1 and a passage at the aforementioned second given position P2).

Also in this case, it is understood that according to alternative non-limiting embodiments, the aforementioned processing device could be configured to estimate the aforementioned quantity correlated with the moving speed of the conveyor device 5 (in particular, of the belt 8 of the conveyor device 5) also as a function of the time interval elapsing between the emission of a detection signal by the detector 13 and a detection signal by the detector 13′.

The presence of the further detector 13′allows to increase the precision with which this quantity correlated with the moving speed is estimated and therefore the robustness of the detection unit 11.

According to some advantageous but £ non-limiting embodiments the (in particular, each) detector 13, 13′ comprises (in particular, is) a detector of inductive type, a photocell of known type.

According to some advantageous but non-limiting embodiments, the detection unit 11 further comprises a revolution counter 14 which is configured to count, in use (i.e. when the conveyor device 5 is in use), the revolutions of at least one of the driving rollers 70 and to zero the count each time the detector 13 emits a detection signal, so as to register the number of revolutions between the emission of two following detection signals emitted by the detector 13. Advantageously but not in a limiting manner, said number of revolutions is proportional to the aforementioned quantity correlated with the distance covered by the reference 12 between the emission of two following detection signals by said detector 13.

This number of revolutions is also proportional to the time interval elapsing between the emission of two following detection signals by said photoelectric detector 13).

Advantageously but not in a limiting manner, the counter 14 is connected with the processing device to transmit at least the number of revolutions between the emission of two following detection signals emitted by the detector 13 to the processing device. Which processing device is configured to evaluate the aforementioned quantity correlated with the distance covered by the reference 12 (in particular, advantageously but not in a limiting manner, the time interval elapsing) between the emission of two following detection signals by the detector 13, based on this number of revolutions, and, therefore, to estimate based on this data the quantity correlated with the moving speed.

According to some advantageous but non-limiting embodiments, the revolution counter 14 comprises (in particular, is) an incremental encoder known per se (and schematically shown in FIGS. 2, 3 and 4); even more advantageously but not in a limiting manner, arranged on one of the two driving rollers 70. More particularly, advantageously but not in a limiting manner, the encoder 14 is configured to detect a rotation and a rotation speed of the driving roller 70 to which it is fixed based on the count of the number of pulses per revolution. The processing device is configured to evaluate the quantity correlated with the moving speed of the conveyor device 5 by comparing this number of pulses between two corresponding detection signals emitted by the detector 13 and/or by the detector 13′ (as will be better explained below) and compare this number of pulses with the previous one (i.e. with the number of pulses between the two previous detection signals emitted by the detector 13 and/or by the detector 13′) and/or with a theoretical number of pulses, and then register an increase or a decrease in the quantity correlated with the moving speed of the conveyor device 5, based on which the control unit CU adjusts (i.e. anticipates or delays) the operation of the different digital printing devices 10, as will be explained below.

According to some advantageous but not exclusive embodiments, when there is provided also the further photoelectric detector 13′, the revolution counter 14 is configured to zero the count each time the processing device receives a detection signal from the further detector 13′ and to restart the count each time the processing device receives a detection signal from the detector 13, so as to register the number of revolutions that are necessary (and therefore the distance covered by the reference 12, i.e. the elapsed time) for the reference 12 to pass from the first given position P1 to the second given position P2. According to other embodiments, even when there is provided the further detector 13′, the revolution counter 14 is configured to zero the count each time the processing device receives a detection signal from the photoelectric detector 13 and to store the count number (i.e. the number of revolutions) corresponding to the instant in which the processing device receives a detection signal from the further detector 13′ so as to also register the number of revolutions that is necessary (and therefore the distance covered by the reference 12, i.e. the elapsed time and) for the reference 12 to pass from the first given position P1 to the second given position P2.

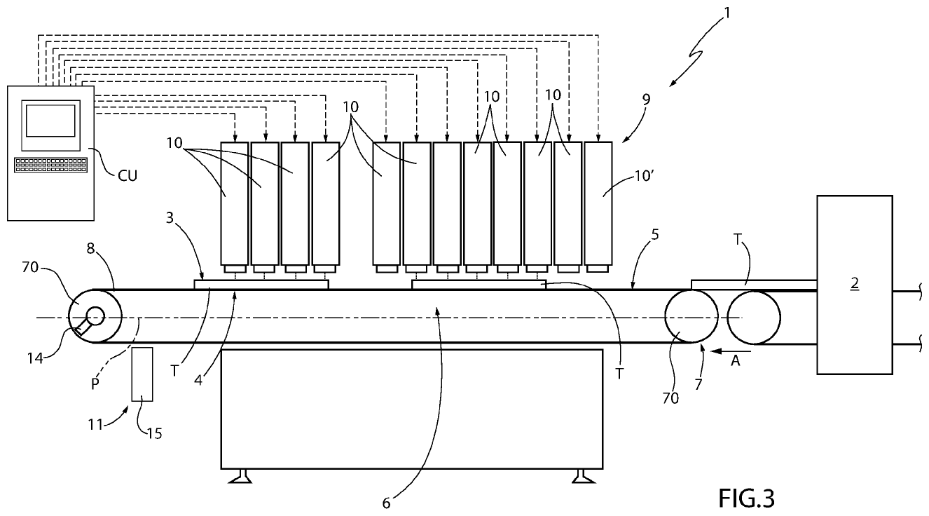

Alternatively or in combination, according to some embodiments such as those described in FIGS. 3 and 4, the detection unit 11 comprises a temperature detector 15 configured to detect, advantageously but not in a limiting manner continuously, the temperature of the belt 8 of the conveyor device 5. In this case, the control unit CU is configured to estimate the quantity correlated with the moving speed as a function of the temperature detected by said temperature detector 15.

Advantageously but not in a limiting manner, said temperature sensor 15 is arranged in contact with said belt 8 below the transport plane.

According to some advantageous but non-limiting embodiments, the control unit CU is configured to operate the aforementioned first digital printing device 10′ in a first given time instant and the remaining printing devices 10 which are arranged downstream of the first digital printing device 10′ along the moving direction A, each one, after a relative given time interval from the first time instant and to adjust the duration of each one of said relative given time intervals as a function of the quantity correlated with the moving speed of the conveyor device 5 estimated by the detection unit 11 (according to any of the embodiments described above).

In particular, advantageously but not in a limiting manner, the control unit CU is configured to vary the operation of each digital printing device 10 subsequent to the first one with respect to the first digital printing device 10′, respectively, delaying or anticipating such operation as the quantity correlated with the moving speed increases or decreases.

In other words, the control unit CU is configured to increase or decrease each one of such relative time intervals, respectively, as the quantity correlated with the moving speed decreases or increases.

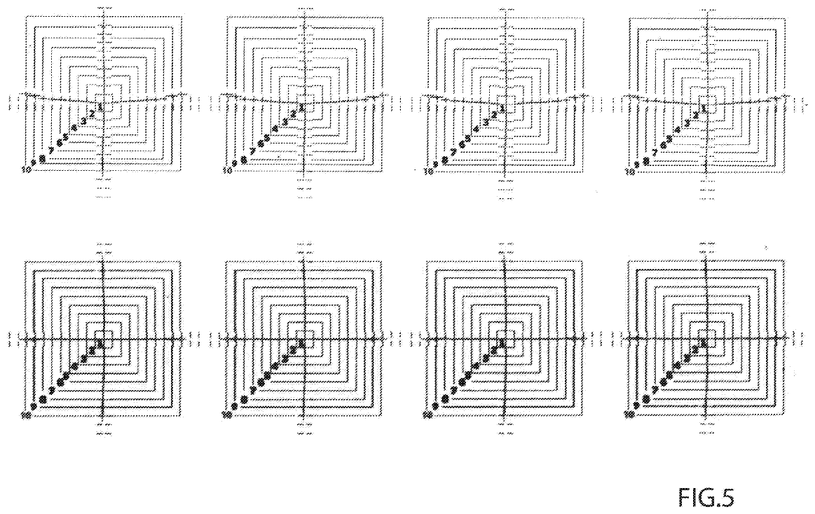

Advantageously but not in a limiting manner, the control unit CU is configured to operate each one of the digital printing devices 10 of the printing assembly 9 so that each one of them applies at least a predefined part of the defined pattern on the surface 3 to be decorated of the ceramic article T and to move the aforementioned predefined part of the defined pattern forward or backward, along the moving direction A, based on the quantity correlated with the speed of the conveyor device 5. In other words, the control unit CU is configured to deform and/or move this predefined part of the defined pattern that is applied by each digital printing device 10 in relation to the actual moving speed of the conveyor device 5, and therefore of the ceramic article T, so as to ensure the correct application of the aforementioned defined pattern also when the external conditions, for example of the temperature and/or of all those conditions that entail a variation in the moving speed of the conveyor device 5 vary (see the patterns below in FIG. 5 made by the decoration machine 1, in particular compare these patterns below made by the decoration machine 1 with the patterns above made with a traditional decoration machine).

Alternatively or in addition, the control unit CU is configured to vary the length of this predefined part of the defined pattern that each printing device 10 makes on the surface 3 to be decorated of the ceramic article T, as a function of the aforementioned quantity correlated with the moving speed.

According to some non-limiting embodiments, the control unit CU is connected to the detection unit and to the printing assembly 9, in particular to each printing device 10 (as schematically shown in FIGS. 2 to 4), in particular to receive data from the detection unit 11 and to transmit them to the printing assembly 9. In some non-limiting cases, the control unit CU is provided with a processing device which is directly part of the detection unit 11. Alternatively, the control unit CU is a centralized system external to the detection unit and/or to the printing assembly 9. According to still other variants, this control unit CU is directly part of the printing assembly 9.

In accordance with a further aspect of the present invention, there is proposed a plant 100 to manufacture ceramic products (not visible in the attached figures), such as for example ceramic slabs and tiles.

The plant 100 comprises: at least one feeding device 16 to feed powder ceramic material CP at a feeding station 17; a forming unit 18 of known type, arranged at a forming station 19 and configured to form at least one ceramic article T; and a conveyor assembly 20 to convey along a path PP in a moving direction A the powder ceramic material CP from the feeding station 17 to the forming station 19 and the ceramic article T from the forming station 19 to a drying station 21.

Advantageously but not in a limiting manner, the forming unit 18 comprises a compactor device 23, per se known and not described in detail here, configured to compact the powder ceramic material CP so as to form a layer of compacted ceramic powder KP and a cutting assembly 24 which is configured to cut said layer of compacted ceramic powder KP at least transversely to the moving direction A so as to form a plurality of ceramic articles T.

Advantageously, the plant 100 also comprises a decoration machine 1, advantageously realized according to any one of the embodiments described above, which is arranged at a printing station 6 and is configured to apply a defined pattern on a surface 3 to be decorated of the ceramic article T as explained above; and a firing kiln 22 to sinter the ceramic article T so as to obtain finished ceramic products, therefore ceramic slabs or tiles.

Advantageously but not in a limiting manner, the plant 100 also comprises a dryer 2 which is arranged at the drying station 21 along the path PP and is configured to subject the ceramic article T to a temperature of at least circa 80° C. (in particular, up to circa 100° C.) so as to obtain a dried ceramic article T.

Advantageously but not in a limiting manner, the conveyor assembly 20 is configured to feed the ceramic article T, advantageously but not in a limiting manner dried, from the drying station 21 to the printing station 6, described above with reference to the decoration machine 1, which advantageously but not in a limiting manner extends downstream of the drying station 21 at a distance from said drying station 21 of circa 130 metres at most (in particular, this distance ranges from circa 45 metres to circa 130 m).

With particular reference to FIG. 1, advantageously but not in a limiting manner, the path PP comprises the aforementioned given path P. In other words, the given path P is a segment of the path PP that extends at the aforementioned printing station 6.

According to still a third aspect of the present invention, there is proposed a method for the surface decoration of a ceramic article T.

Advantageously, the method comprises: a conveying step, during which a ceramic article T is conveyed by a conveyor device 5 (advantageously of the type described above) along a given path P, in a moving direction A, through a printing station 6; a printing step, which is (at least partially) simultaneous with the conveying step, during which a printing assembly 9 which is arranged at the printing station 6 and is provided with a plurality of digital printing devices 10 (advantageously of the type described above) arranged one after the other along the moving direction A, applies a defined pattern on a surface 3 to be decorated of the ceramic article T, which ceramic article T advantageously but not in a limiting manner has undergone a drying heat treatment, at a temperature of at least circa 80° C. (in particular, at least circa 100° C.), no more than 3 minutes (in particular, no more than 4 minutes) before said printing step.

Advantageously, the method also comprises a detection step, which is (at least partially) simultaneous with the conveying step, during which a detection unit 11 (advantageously of the type described above in relation to the decoration machine 1) detects, advantageously but not in a limiting manner continuously, a quantity correlated with the moving speed of the conveyor device 5; and a control step, which is at least partially subsequent to the detection step, during which a control unit CU adjusts, advantageously but not in a limiting manner retroactively, the mutual operation of the different digital printing devices 10 of the printing assembly 9, as a function of the quantity correlated with the moving speed of the conveyor device 5 (detected during said detection step) so as to apply the defined pattern on the surface 3 to be decorated of the ceramic article T also upon variation of (i.e. regardless of) the actual moving speed of the conveyor device 5, i.e. regardless of the different factors, such as for example temperature and actual pull of the belt 8 which might influence the speed of the aforementioned conveyor device 5.

Advantageously but not in a limiting manner, also in this case, the conveyor device 5 of the aforementioned conveying step comprises, in turn, a metal support structure 7, which advantageously but not in a limiting manner comprises in turn a pair of parallel driving rollers 70 (schematically represented in FIGS. 2 to 4) at a given distance from one another along the moving direction A, and a belt 8 which is fitted on the metal support structure 7 (in particular, on the pair of rollers 70) and defines with a branch thereof a transport plane to support and transport the ceramic article T during its movement. This given distance between the driving rollers 70, advantageously but not in a limiting manner, ranges from circa 2.5 metres to circa 12 metres (in particular, from circa 3 metres to circa 10 metres; even more in particular, equal to circa 4 metres).

Advantageously but not in a limiting manner, the control step comprises, in turn: a first operating sub-step, during which the control unit operates a first digital printing device 10′ of the plurality of digital printing devices 10 of the printing assembly 9 in a first given time instant; at least a second operating sub-step, during which the control unit CU operates the remaining digital printing devices 10, which are arranged downstream of the first digital printing device 10′ along the moving direction A, each one, after a relative given time interval from the first time instant; and an adjustment sub-step, which is (at least partially) simultaneous with the second operating step and during which the control unit CU adjusts the duration of each one of relative given time intervals as a function of the quantity correlated with the moving speed of the conveyor device 5.

According to some advantageous but not exclusive embodiments of the present invention, the detection step comprises, in turn, a reading sub-step, during which at least one detector 13 (which advantageously is part of the detection unit 11, as described above in relation to the decoration machine 1) detects each passage of a reference 12 (also part of the detection unit 11 and fixed to the belt 8 of the conveyor device 5, as described above) at the first given position Pl and emits a detection signal, and a sub-processing step, during which a processing device (which is part of the detection unit 11 as mentioned above in relation to the decoration machine 1) receives the detection signals emitted by the detector 13 and estimates the quantity correlated with the moving speed of the conveyor device 5 as a function of the variation over time of a quantity correlated with (in particular, coinciding with) the distance covered by the reference 12 between the emission of two following detection signals.

In addition, according to some advantageous but non-limiting embodiments, during the aforementioned processing step, a revolution counter 14 (advantageously of the type described above in relation to the decoration machine 1) counts the number of revolutions made by at least one of the driving rollers 70 of the metal structure 7 in the interval elapsing between the emission of two first detection signals and the processing device estimates the quantity correlated with the moving speed of the conveyor device 5 also as a function of said number of revolutions counted by the revolution counter 14.

In addition or alternatively, according to some advantageous but non-limiting embodiments, the detection step comprises, in turn, a temperature detection sub-step, during which a temperature detector 15, which advantageously but not in a limiting manner is part of the detection unit 11, advantageously continuously detects the temperature of the belt 8 of the conveyor device 5. According to some advantageous but non-limiting embodiments, as already explained in relation to the machine 1, the quantity correlated with the moving speed is a function of the temperature; in particular, it is proportional to the detected temperature.

Advantageously but not necessarily, the method for the surface decoration of a ceramic article T is implemented by the decoration machine 1 described above (in accordance with the second aspect of the present invention).

According to yet a last aspect of the present invention, there is proposed a method to manufacture a ceramic product; in particular, a ceramic slab or tile; the method comprises the following steps: a feeding step to feed powder ceramic material CP at a feeding station 17; a forming step, during which a forming unit 18, arranged at a forming station 19, forms at least one ceramic article T. Advantageously but not in a limiting manner, this forming step comprises a compacting sub-step, during which the powder ceramic material CP is compacted, advantageously but not in a limiting manner by means of the compactor device 23 mentioned above with reference to the plant 100, so as to form a layer of compacted ceramic powder KP and a cutting sub-step, during which the layer of compacted ceramic powder KP is cut, advantageously by means of the aforementioned cutting unit 24, at least transversely to the moving direction A so as to form a plurality of ceramic articles T.

Advantageously but not in a limiting manner, the method also provides for a decoration step, during which the ceramic article T is decorated by implementing the decoration method described above (in accordance with the second aspect of the present invention). Even more advantageously but not in a limiting manner, said decoration step is implemented with a decoration machine 1 according to the first aspect of the present invention.

According to some advantageous but non-limiting embodiments, the manufacturing method further comprises a drying step, which is (at least partially) subsequent to the forming step and (at least partially prior) to the decorating step, during which drying step the ceramic article T is dried, by being subjected inside a dryer 2 to a temperature of at least circa 80° C. (in particular, at least circa 100° C.).

Advantageously but not in a limiting manner, the decoration step and the drying step are distanced/spaced apart from one another by circa 3 minutes at most, in particular by circa 4 minutes at most.

Advantageously but not necessarily, the method to manufacture the ceramic product is implemented by the plant 100 described above (in accordance with the second aspect of the present invention). In this case, when the plant 100 provides a dryer 2 arranged upstream of the printing station 6 along said path PP, it is advantageously but not in a limiting manner is configured so that the printing station 6 extends at a distance from the drying station 21 of circa 130 metres at most (in particular, ranging from circa 45 metres to circa 130 metres).

The decoration method and machine 1 for the surface decoration of ceramic articles T of the present invention have numerous advantages, among which we mention the following.

Thanks to the detection of a quantity correlated with the moving speed of the conveyor device 5 and the consequent retroactive adjustment of the (mutual) operation of the different digital printing devices 10 of the printing assembly 9, the decoration machine 1 and the method for the surface decoration of a ceramic article T of the present invention allow applying the aforementioned defined pattern on the surface 3 to be decorated of the ceramic article T with high precision, compensating for the defects or phase shifts of the defined pattern which, in the absence of such retroactive adjustment, would be induced by the dimensional variations of the conveyor device 5, which induce consequent variations in the moving speed of the ceramic articles T. In other words, thanks to the solution proposed in the present invention it is possible to improve the aesthetic appearance of the finished ceramic products, guaranteeing at the same time, a very high degree of resolution and a correct synchronization of the operation of the various digital printing devices 10 of the printing assembly 9 regardless of the expansion and/or shrinkage and/or deformation phenomena to which the conveyor device 5 (in particular, the metal support structure 7 of the conveyor device 5) is subjected during its useful life, as can be seen by comparing the diagrams at the top and bottom in FIG. 5.

1. A decoration machine for the surface decoration of a ceramic article the decoration machine comprises:
a conveyor device which is configured to convey the ceramic article along a given path, in a moving direction, through a printing station and comprises, in turn, a metal support structure and a belt which is fitted on the metal support structure and defines a transport plane to support and transport the ceramic article said printing station extending along said moving direction for a length of at least circa 2 metres;
a printing assembly, which is arranged at said printing station is configured to apply a defined pattern on a surface to be decorated of the ceramic article and comprises a plurality of digital printing devices arranged in succession along said moving direction;
a control unit configured to operate each one of said digital printing devices of the printing assembly; and
a detection unit which is configured to detect a quantity correlated with the moving speed of said conveyor device and comprises a reference which is integral to said belt, at least one detector configured to detect each passage of said reference at a first given position and to emit a corresponding first detection signal, and a processing device connected to the detector to receive each first detection signal and estimate said quantity correlated with the moving speed of said conveyor device as a function of the variation of a quantity correlated with (in particular, coinciding with) the distance covered by said reference between the emission of two following first detection signals;
the control unit being configured to adjust the mutual operation of the different digital printing devices of said printing assembly as a function of said quantity correlated with the moving speed of said conveyor device so as to apply said defined pattern on the surface to be decorated of the ceramic article.

2. The decoration machine according to claim 1, wherein: said control unit is configured to operate a first digital printing device of said plurality of digital printing devices of said printing assembly in a first given time instant, the remaining digital printing devices of said printing assembly, which are arranged downstream of said first digital printing device along said moving direction, each one after a relative given time interval from said first time instant, and to adjust the duration of each one of said relative given time intervals as a function of said quantity correlated with the moving speed of said conveyor device.

3. The decoration machine according to claim 1, wherein said control unit is configured to operate each one of said digital printing devices of the printing assembly so that each one of them applies at least a predefined part of said defined pattern on said surface to be decorated of the ceramic article and to move said predefined part of said defined pattern forward or backward, along said moving direction, based on said quantity correlated with the moving speed of said conveyor device.

4. The decoration machine according to claim 1, wherein:
said metal support structure comprises a pair of parallel driving rollers at a given distance from one another along said moving direction and said belt is fitted on said pair of driving rollers so as to be stretched and operated, in its movement, by the rotation of said driving rollers; and
said detection unit comprises a revolution counter, which is connected to said processing device and is configured to count the revolutions of at least one of the driving rollers of said pair of driving rollers and to zero the count each time said at least one detector emits a first detection signal, so as to register the number of revolutions between the emission of two following first detection signals; said number of revolutions between the emission of two following first detection signals being proportional to said quantity correlated with the distance covered by said reference between the emission of two following first detection signals.

5. The decoration machine according to claim 1, wherein said detection unit comprises a further detector configured to detect each passage of said reference at a second given position and to emit a corresponding second detection signal; said second given position being arranged downstream of said first given position along said given path; and
said processing device being configured to estimate said quantity correlated with the moving speed of said conveyor device also as a function of the variation of a quantity correlated with the distance covered by said reference between the emission of a first detection signal and the emission of a second detection signal.

6. The decoration machine for ceramic articles according to claim 1, wherein said detection unit comprises a temperature detector configured to detect the temperature of the belt of said conveyor device; said quantity correlated with the moving speed being a function of said temperature.

7. The decoration machine according to claim 1, wherein the printing assembly comprises at least six ink jet printing devices arranged in succession along said moving direction.

8. A plant to manufacture ceramic products; in particular, ceramic slabs or tiles; the plant comprises:
a feeding device to feed powder ceramic material at a feeding station;
a forming unit arranged at a forming station and configured to form at least one ceramic article;
a conveyor assembly to convey, along a path in a moving direction the powder ceramic material from the feeding station to the forming station and said at least one ceramic article from the forming station to a printing station;
a decoration machine according to claim 1, which is arranged at said printing station and configured to apply said defined pattern on a surface to be decorated of said ceramic article; and
at least one firing kiln to sinter the ceramic article so as to obtain ceramic product.

9. The plant to manufacture ceramic products according to claim 8, comprising a dryer, which is arranged at a drying station arranged upstream of said printing station along said path and is configured to subject the ceramic article to a temperature of at least circa 80° C. so as to obtain a dried ceramic article;
said conveyor assembly being configured to feed said dried ceramic article from said drying station to said printing station which extends downstream of said drying station at a distance from said drying station of at most circa 130 metres along said path (in particular, along said given path, which is a segment of said path).

10. A method for the surface decoration of a ceramic article the method comprises:
a conveying step, during which a ceramic article is conveyed by a conveyor device along a given path in a moving direction through a printing station;
a printing step, which is at least partially simultaneous with said conveying step and during which a printing assembly, which is arranged at said printing station and is provided with a plurality of digital printing devices arranged in succession along said moving direction applies a defined pattern on a surface to be decorated of the ceramic article;
a detection step, which is at least partially simultaneous with said conveying step and during which a detection unit detects a quantity correlated with the moving speed of said conveyor device; and
a control step, which is at least partially subsequent to said detection step and during which a control unit adjusts the mutual operation of the different digital printing devices of said printing assembly as a function of said quantity correlated with the moving speed of said conveyor device detected during said detection step, so as to apply said defined pattern on the surface to be decorated of the ceramic article;
said conveyor device comprising a metal support structure and a belt, which is fitted on said metal support structure and defines a transport plane to support the ceramic article;
said detection unit comprising a reference integral to said belt; and
said detection step comprising, in turn, a reading sub-step, during which at least one detector detects each passage of said reference at a first given position and emits a detection signal, and a processing sub-step, during which a processing device receives the detection signals emitted by said at least one detector and estimates said quantity correlated with the moving speed of said conveyor device as a function of the distance between the emission of two following detection signals.

11. The method for the surface decoration of a ceramic article according to claim 10, wherein said control step comprises, in turn:
a first operating sub-step, during which said control unit operates a first digital printing device of said plurality of digital printing devices of said printing assembly in a first given time instant;
at least a second operating sub-step, during which said control unit operates the remaining digital printing devices of said printing assembly, which are arranged downstream of said first digital printing device along said moving direction, each one after a relative given time interval from said first time instant; and
an adjustment sub-step, which is at least partially simultaneous with said second operating step and during which said control unit adjusts the duration of each one of said relative given time intervals as a function of said quantity correlated with the moving speed of said conveyor device.

12. The method for the surface decoration of a ceramic article according to claim 10 wherein:
said metal support structure comprises a pair of parallel driving rollers at a given distance from one another ranging from circa 2.5 metres to circa 12 metres along said moving direction and said belt is fitted on said pair of driving rollers so as to be stretched and operated, in its movement, by the rotation of said driving rollers; and
during said processing sub-step, a revolution counter counts the number of revolutions made by at least one of said driving rollers in the interval elapsing between the emission of two following first detection signals and said processing device estimates said quantity correlated with the moving speed of said conveyor device also as a function of said number of revolutions counted by said revolution counter.

13. The method for the surface decoration of a ceramic article according to claim 10, wherein:
said detection step comprises, in turn, a temperature detection sub-step, during which a temperature detector detects the temperature of the belt of said conveyor device; said quantity correlated with the moving speed being a function of said temperature.

14. The method for the surface decoration of a ceramic article according to claim 10, wherein said detection unit comprises: said at least one detector configured to detect each passage of said reference at a first given position and to emit a corresponding first detection signal, said processing device; and a further detector configured to detect each passage of said reference at a second given position and to emit a corresponding second detection signal; said second given position being arranged downstream of said first given position along said given path;
said processing device being configured to estimate said quantity correlated with the moving speed of said conveyor device also as a function of the variation of a quantity correlated with the distance covered by said reference between the emission of a first detection signal and the emission of a second detection signal.

15. The method to manufacture a ceramic product in particular, a ceramic a slab or tile; the method comprises the following steps:
a feeding step to feed powder ceramic material at a feeding station;
a forming step, during which a forming unit arranged at a forming station forms at least one ceramic article; and
a decoration step, which is carried out according to the decoration method of claim 10.

16. The method to manufacture a ceramic product according to claim 15, comprising a drying step, which is at least partially subsequent to said forming step and during which said ceramic article is dried by being subjected, inside a dryer, to a temperature of at least circa 80° C.;
said decoration step and said drying step being distanced/spaced apart from one another by by 4 minutes or less.
